(19) United States
(12) Patent Application Publication
(10) Pub. No.: US 2022/0193468 A1
(43) Pub. Date: Jun. 23, 2022

(54) FIBRE FILTER AND METHOD OF MANUFACTURE THEREOF

(71) Applicant: Owners Capital GmbH, Munich (DE)

(72) Inventor: Michel Gschwendtner, Munich (DE)

(21) Appl. No.: 17/131,721

(22) Filed: Dec. 22, 2020

(51) Int. Cl. A62B 23/02; A62D 9/00; B01D 39/16; B01D 46/00

(52) U.S. Cl. CPC A62B 23/025; B01D 46/0002; B01D 39/1623; A62D 9/00

(57) ABSTRACT

There is disclosed a fibre filter (10) for filtering a flow of gas therethrough, wherein the fibre filter (10) includes a fibre felt (30) including at least one fibre (20) that is matted together, wherein the at least one fibre (20) is manufactured from a plastics material that includes integrally therein a disinfecting agent that inhibits activity of microbes that are deposited on the at least one fibre (20) when the flow of gas occurs through the fibre filter (10). The fibre filter (10) is susceptible to being used in face masks (50) and air filters (150) of air-conditioning units, although many other uses are feasible.

### TECHNICAL FIELD

The present disclosure relates generally to a fibre (US English: “fiber”) filter that is configured to provide antimicrobial activity when in use. Moreover, the present disclosure relates to a method for (namely, a method of) manufacturing the aforesaid fibre filter. Moreover, the present disclosure relates to a method of manufacturing fibres for the aforesaid fibre filter.

### BACKGROUND

Pathogen-eliminating HVAC air filters are known. Such filters are configured to capture airborne particles which may contain pathogens and viruses such as SARS-CoV-2. Moreover, such filters are capable of eliminates 99.99% of such pathogens and viruses. The aforesaid filters utilize a water-based latex compound with alumina tri-hydrate impregnation for fire and smoke protection. Moreover, Silver technology is utilized for achieving an antiviral and antibacterial effect, wherein Silver attracts bacteria and viruses within a structure of the air filters, thereby killing the bacteria, and destroying common harmful enveloped viruses within minutes. A significantly extended operating life-time for the filters is achieve compared to paper or single-layer foam filters.

Use of Silver as an ingredient in the filters adds to their cost of manufacture and also represents an environmental disposal problem.

### SUMMARY

The present disclosure seeks to provide an improved fibre filter that is less costly to manufacture and avoids a need to use Silver as an antimicrobial ingredient.

The present disclosure seeks to provide an improved fibre filter that maintains its antimicrobial properties more effectively during a period of use.

The present disclosure also seeks to provide an improved method of (namely, a method for) manufacturing the aforesaid fibre filter.

In one aspect, there is provided a fibre filter for filtering a flow of gas therethrough, wherein the fibre filter includes a fibre felt including at least one fibre that is matted together, wherein the at least one fibre is manufactured from a plastics material that includes integrally therein a disinfecting agent that inhibits activity of microbes that are deposited on the at least one fibre when the flow of gas occurs through the fibre filter.

The invention is of advantage in that including the disinfecting agent integrally within the fibre avoids a need to coat the fibre, for example after matting of the fibre has been performed to generate fibre felt, thereby simplifying manufacture of the fibre filter, and wherein the disinfecting agent included within the fibre is able to contribute to an antimicrobial performance of the fibre filter.

Optionally, the fibre filter is configured to inhibit the microbes, wherein the microbes include at least one of: bacteria, viruses, fungi.

Optionally, in the fibre filter, the plastics material includes at least one of: polyester, polyethylene, polypropylene, polyethylene terephthalate, polyvinyl chloride, polystyrene, polylactic acid, polycarbonate, polymethyl methacrylate, polyoxymethylene, aliphatic polyamide (nylon), semi-aromatic polyamide (nylon), acrylonitrile butadiene styrene, acrylic plastics material.

Optionally, in the fibre filter, the at least one fibre is porous to allow the microbes to migrate into the at least one fibre. Such migration enables the microbes to come more effectively in contact with the disinfecting agent to inhibited, for example killed.

Optionally, in the fibre filter, the at least one fibre is porous and includes a diffusing agent that is arranged to transport the disinfecting agent from within the at least one fibre to an outer surface of the at least one fibre to replenish its anti-microbial characteristics as a function of an age of the fibre filter.

Optionally, in the fibre filter, the disinfecting agent includes a polymeric guanidine derivative. More optionally, in the fibre filter, the polymeric guanidine derivative is based on a diamine containing oxyalkylene chains between two amino groups, with a combination polymeric guanidine derivative based on a diamine containing oxyalkylene chains between two amino groups, with the guanidine derivative representing a product of polycondensation between a guanidine acid addition salt and a diamine containing polyoxyalkylene chains between two amino groups. Yet more optionally, the disinfecting agent further includes at least one of: hexa methylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent, poly(hexamethylendiamine guanidinium chloride), Polietheramine derivatives (JEFF AMINE EDR-148), Polietheramine (Triethyleneglycol diamine (TEGDA)) enzymes, PGPR, amino acids, antioxidants including humic acids, and phytotherapeutic plant extracts. Yet more optionally, in the fibre filter, the disinfecting agent has an average molecular mass in a range of 500 to 3000. More optionally, in the fibre filter, the guanidinium derivative includes oligo(2-(2-ethoxy)ethoxy ethyl guanidinium chloride).

Optionally, in the fibre filter, the at least one fibre has a diameter in a range of 50 μm to 1 mm.

Optionally, in the fibre filter, the fibre felt has a thickness in a range of 0.5 mm to 5.0 mm. More optionally, in the fibre filter, the fibre felt has a thickness in a range of 1 mm to 3 mm.

Optionally, in the fibre filter, a ratio of volume of the at least one fibre within the fibre felt relative to a volume of voids present in the fibre felt is in a range of 50:50 to 5000:50.

Optionally, in the fibre filter, the disinfecting agent is arranged to inhibit bacteria, wherein the bacteria include at least one of: Bordetella pertussis, Borrelia burgdorferi, Brucella abortus, Brucella canis, Brucella melitensis, Brucella suis, Campylobacter jejuni, Chlamydia pneumonia, Chlamydia psittaci, Chlamydia trachomatis, Clostridium botulinum Clostridium difficile, Clostridium perfringens, Clostridium tetani, Corynebacterium diphtheria, Enterococcus faecalis, Enterococcus faeciurn, Escherichia coil (E. coli), Enterotoxigenic Escherichia coli (ETEC), Enteropathogenic E. coli, Erancisella tularensis, Haemophilus influenza, Helicobacter pylori, Legionella pneumophila, Leptospira interrogans, Listeria monocytogenes, Mycobacterium leprae, Mycobacterium tuberculosis, Mycoplasma pneumonia, Neisseria gonorrhoeae, Neisseria meningitidis, Pseudomonas aeruginosa, Rickettsia rickettsia, Salmonella typhi, Salmonella typhimurium, Shigella sonnei, Staphylococcus epidermidis, Staphylococcus saprophyticus, Streptococcus agalactiae, Streptococcus mutans Streptococcus pneumonia, Streptococcus pyogenes, Treponema pallidum, Vibrio cholera, Vibrio harveyi and Yersinia pestis.

Optionally, in the fibre filter, the disinfecting agent is arranged to inhibit fungi, wherein the fungi include at least one of: Absidia corymbifera, Ajellomyces capsulatus, Ajellomyces dermatitidis, Arthroderma benhamiae, Arthroderma fulvum, Arthroderma gypseum, Arthroderma incurvatum, Arthroderma otae, Arthroderma vanbreuseghemii, Aspergillus flavus, Aspergillus fumigates, Aspergillus niger, Blastomyces dermatitidis, Candida albicans, Candida albicans var. stellatoidea, Candida dublinensis, Candida glabrata, Candida guilliermondii, Candida krusei, Candida parapsilosis, Candida pelliculosa, Candida tropicalis, Cladophialophora carrionii, Coccidioides immitis, Cryptococcus neoformans, Cunninghamella sp., Epidermophyton floccosum, Exophiala dermatitidis, Eilobasidiella neoformans, Eonsecaea pedrosoi, Geotrichum candidum, Histoplasma capsulatum, Hortaea wemeckii, Issatschenkia orientalis, Madurella grisae, Malassezia furfur, Malassezia furfur complex, Malassezia globosa, Malassezia obtuse, Malassezia pachydermatis, Malassezia restricta, Malassezia slooffiae, Malassezia sympodialis, Microsporum canis, Microsporum fulvum, Microsporum gypseum, Microsporum gypseum complex, Microsporum gypseum, Mucor circinelloides, Nectria haematococca, Paecilomyces variotii, Paracoccidioldes brasiliensis, Penicillium marneffei, Phialophora verrucosa, Pichia anomala, Pichia guilliermondii, Pneumocystis jirovecii, Pseudallescheria boydii, Rhizopus oryzae, Rodotorula rubra, Saccharomyces cerevisiae, Scedosporium apiospermum, Schizophyllum commune, Sporothrix schenckii, Stachybotrys chartarum. Trichophyton mentagrophytes. Trichophyton mentagrophytes complex, Trichophyton mentagrophytes. Trichophyton mentagrophytes. Trichophyton rubrum, Trichophyton tonsurans.

According to a second aspect, there is provided a face mask for protecting a user thereof from inhaling or exhaling microbes, wherein the face mask includes an outwards-facing fabric layer when the face mask is worn by the user, an inwards-facing fabric layer that faces towards a mouth and a nose of the user when the face mask is worn by the user, and a fibre filter of the first aspect included between the outwards-facing fabric layer and the inwards-facing fabric layer, wherein the fibre filter is configured to collect microbes from an air flow through the face mask when in use, and to inhibit microbial activity of the microbes.

Optionally, the face mask includes a rigidity-enhancing element included in the face mask in a region thereof that abuts onto the nose of the user when the face mask is worn by the user.

More optionally, the face mask includes a strap arrangement that is secured around at least parts of ears of the user when the face mask is being worn by the user, wherein the strap arrangement is configured to hold the face mask against the mouth and the nose of the user. More optionally, in the face mask, the strap arrangement is implemented as elastic loop straps.

According to a third aspect, there is provided an air-filter for a heat pump unit (namely, an air conditioning unit), wherein the air-filter includes a fibre filter of the first aspect, wherein the fibre filter is supported by a frame that is configured to be fitted into the heat pump unit to intercept a flow of heated or cooled air between the heat pump unit and a spatial environment in which microbial activity is to be inhibited.

According to fourth aspect, there is provided a method for manufacturing a fibre for use in a fibre filter of the first aspect, wherein the method includes:
(i) providing a plastic feedstock arrangement including a plastics material reservoir and a disinfecting agent reservoir;
(ii) mixing and heating a mixture of a plastics material provided from the plastics material reservoir and a disinfecting agent provided from the disinfecting agent reservoir to generate a melt; and
(iii) pulling from the melt of the plastic feedstock arrangement a quantity of the plastics material mixed with a quantity of the disinfecting agent through an aperture to generate the fibre,

wherein the fibre includes the disinfecting agent disposed throughout the fibre.

Optionally, the method further includes arranging for the fibre to be porous so that microbes collecting thereon when the fibre is in use are able to migrate into an inner volume of the fibre to be inhibited therein.

Optionally, the method further includes adding a diffusing agent to the plastic feedstock arrangement that causes diffusion of the disinfecting agent from an interior of the fibre to an external surface of the fibre to replenish the external surface of the fibre with the disinfecting agent as a function of time when the fibre is in use. The diffusing agent can be selected from a material that is immiscible with the plastics material. More optionally, the method includes using a silicone oil for the diffusing agent.

Optionally, the method includes selecting the disinfecting agent to be able to withstand a melting temperature of the plastics material.

Optionally, the method includes arranging for the disinfection agent to include a polymeric guanidine derivative based on a diamine containing oxyalkylene chains between two amino groups, with a combination polymeric guanidine derivative based on a diamine containing oxyalkylene chains between two amino groups, with the guanidine derivative representing a product of polycondensation between a guanidine acid addition salt and a diamine containing polyoxyalkylene chains between two amino groups.

More optionally, the method includes arranging for the disinfecting agent to further include at least one of: hexamethylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent, poly(hexamethylendiamine guanidinium chloride), Poliethera mine derivatives (JEFF AMINE EDR-148), Polietheramine (Triethyleneglycol diamine (TEGDA)) enzymes, PGPR, amino acids, antioxidants including humic acids, and phytotherapeutic plant extracts.

Optionally, the method includes arranging for the disinfecting agent to have an average molecular mass in a range of 500 to 3000.

Optionally, the method includes arranging for the guanidinium derivative to include oligo(2-(2-ethoxy)ethoxy ethyl guanidinium chloride).

Optionally, the method includes selecting the aperture in (iii) to have a diameter to produce the fibre to have a diameter in a range of 50 μm to 1 mm.

According to a fifth aspect, there is provided a method for manufacturing a fibre, wherein the method includes:
(i) providing a plastic feedstock arrangement including a plastics material reservoir and a disinfecting agent reservoir;
(ii) mixing and heating a mixture of a plastics material provided from the plastics material reservoir and a disinfecting agent provided from the disinfecting agent reservoir to generate a melt; and
(iii) pulling from the melt of the plastic feedstock arrangement a quantity of the plastics material mixed with a quantity of the disinfecting agent through an aperture to generate the fibre,

wherein the fibre includes the disinfecting agent disposed throughout the fibre.

Optionally, the method further includes arranging for the fibre to be porous so that microbes collecting thereon when the fibre is in use are able to migrate into an inner volume of the fibre to be inhibited therein. More optionally, the method further includes adding a diffusing agent to the plastic feedstock arrangement that causes diffusion of the disinfecting agent from an interior of the fibre to an external surface of the fibre to replenish the external surface of the fibre with the disinfecting agent as a function of time when the fibre is in use. Yet more optionally, the method includes using a silicone oil for the diffusing agent.

Optionally, the method includes selecting the disinfecting agent to be able to withstand a melting temperature of the plastics material.

Optionally, the method includes arranging for the disinfection agent to include a polymeric guanidine derivative based on a diamine containing oxyalkylene chains between two amino groups, with a combination polymeric guanidine derivative based on a diamine containing oxyalkylene chains between two amino groups, with the guanidine derivative representing a product of polycondensation between a guanidine acid addition salt and a diamine containing polyoxyalkylene chains between two amino groups. More optionally, the method includes arranging for the disinfecting agent to further include at least one of: hexamethylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent, poly(hexamethylendiamine guanidinium chloride), Polietheramine derivatives (JEFF AMINE EDR-148), Polietheramine (Triethyleneglycol diamine (TEGDA)) enzymes, PGPR, amino acids, antioxidants including humic acids, and phytotherapeutic plant extracts.

Optionally, the method includes arranging for the disinfecting agent to have an average molecular mass in a range of 500 to 3000.

Optionally, the method includes arranging for the guanidinium derivative to include oligo(2-(2-ethoxy)ethoxy ethyl guanidinium chloride).

Optionally, the method includes selecting the aperture in (iii) to have a diameter to produce the at least one fibre to have a diameter in a range of 50 μm to 1 mm.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of a fibre filter pursuant to the present disclosure;

FIG. 2 is an illustration of a face mask pursuant to the present disclosure, wherein the face mask includes the fibre filter of FIG. 1;

FIG. 3 is an illustration of an air-conditioning filter pursuant to the present disclosure, wherein the air-conditioning filter includes the fibre filter of FIG. 1;

FIG. 4 is an illustration of an apparatus for manufacturing fibres for use in manufacturing the fibre filter of FIG. 1; and

FIG. 5 is an illustration of steps of a method for manufacturing the fibre filter of FIG. 1.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present description also relates to the method as described above. The various embodiments and variants disclosed above apply mutatis mutandis to the method.

### DETAILED DESCRIPTION OF THE DRAWINGS

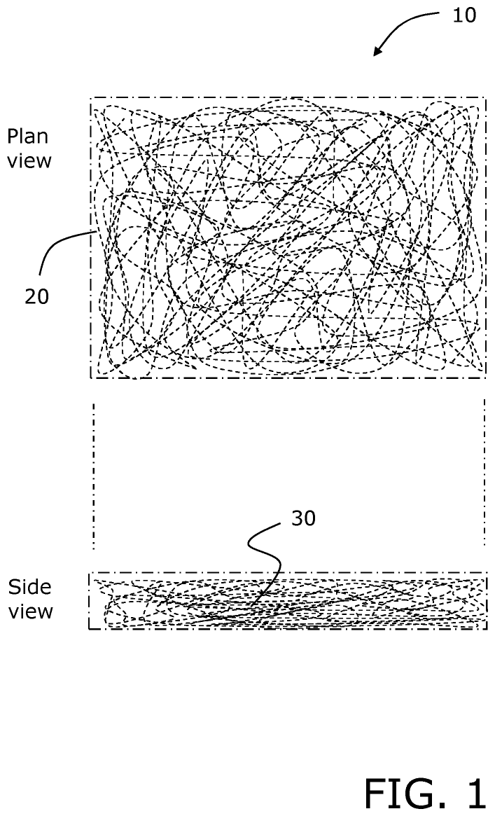

Referring to FIG. 1, there is shown a fibre filter indicated generally by 10. The fibre filter 10 includes at least one fibre 20, for example a plurality of fibres, that is matted together to form a fibre felt 30. The fibre felt 30 has a texture, when touched, that is generally akin to cashmere wool felt. The at least one fibre 20 beneficially has a diameter in a range of 50 μm to 1 mm.

The fibre felt 20, when formed into a layer, beneficially has a thickness in a range of 0.5 mm to 5.0 mm, more optionally in a range of 1 mm to 3 mm. The fibre filter 10 is beneficially manufactured so that a ratio of volume of the at least one fibre 20 within the fibre felt 30 relative to a volume of voids present in the fibre felt 30 is in a range of 50:50 to 5000:50. The fibre filter 10 is beneficially configured to inhibit microbes presented thereto, for example via an air flow occurring through the fibre filter 10, wherein the microbes include at least one of: bacteria, viruses, fungi.

In the fibre filter 10, the at least one fibre 20 is optionally manufactured from a plastics material includes at least one of: polyester, polyethylene, polypropylene, polyethylene terephthalate, polyvinyl chloride, polystyrene, polylactic acid, polycarbonate, polymethyl methacrylate, polyoxymethylene, aliphatic polyamide (nylon), semi-aromatic polyamide (nylon), acrylonitrile butadiene styrene, acrylic plastics material. Alternatively, the at least one fibre 20 can be manufactured using a spun natural fibre, for example from flax, cotton, natural animal wool, and silk, or any combination thereof. Optionally, the at least one fibre 20 includes a combination of the spun natural fibre and the aforesaid plastics material. When a plastics material is employed, for example as aforementioned, a disinfecting agent is beneficially moulded together with the at least one fibre 20, so that the disinfecting agent is integral to the at least one fibre 20; such an approach avoids having to coat the at least one fibre 20 at a later stage when manufacturing the fibre filter 10. Optionally, in the fibre filter 10, the at least one fibre 20 is porous to allow the microbes to migrate into the at least one fibre 20; in other words, an enhanced surface area of the at least one fibre 20 bearing the disinfecting agent is thereby provided, resulting in a greater probability of a given microbe being inhibited, for example killed. Such migration enables the microbes to come more effectively into contact with the disinfecting agent.

Optionally, in the fibre filter 10, the at least one fibre 20 includes the disinfecting agent includes a polymeric guanidine derivative. More optionally, in the fibre filter 10, the at least one fibre 20 includes the polymeric guanidine derivative that is based on a diamine containing oxyalkylene chains between two amino groups, with a combination polymeric guanidine derivative based on a diamine containing oxyalkylene chains between two amino groups, with the guanidine derivative representing a product of polycondensation between a guanidine acid addition salt and a diamine containing polyoxyalkylene chains between two amino groups. Yet more optionally, the disinfecting agent further includes at least one of: hexamethylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent, poly(hexamethylendiamine guanidinium chloride), Polietheramine derivatives (JEFF AMINE EDR-148), Polietheramine (Triethyleneglycol diamine (TEGDA)) enzymes, PGPR, amino acids, antioxidants including humic acids, and phytotherapeutic plant extracts. Yet more optionally, in the fibre filter 10, the disinfecting agent has an average molecular mass in a range of 500 to 3000. More optionally, in the fibre filter, the guanidinium derivative includes oligo(2-(2-ethoxy)ethoxy ethyl guanidinium chloride).

Optionally, in the fibre filter 10, the disinfecting agent is arranged to inhibit bacteria, wherein the bacteria include at least one of: Bordetella pertussis, Borrelia burgdorferi, Brucella abortus, Brucella canis, Brucella melitensis, Brucella suis, Campylobacter jejuni, Chlamydia pneumonia, Chlamydia psittaci, Chlamydia trachomatis, Clostridium botulinum Clostridium difficile, Clostridium perfringens, Clostridium tetani, Corynebacterium diphtheria, Enterococcus faecalis, Enterococcus faecium, Escherichia coil (E. coli), Enterotoxigenic Escherichia coli (ETEC), Enteropathogenic E. coli, Erancisella tularensis, Haemophilus influenza, Helicobacter pylori, Legionella pneumophila, Leptospira interrogans, Listeria monocytogenes, Mycobacterium leprae, Mycobacterium tuberculosis, Mycoplasma pneumonia, Neisseria gonorrhoeae, Neisseria meningitidis, Pseudomonas aeruginosa, Rickettsia rickettsia, Salmonella typhi, Salmonella typhimurium, Shigella sonnei, Staphylococcus epidermidis, Staphylococcus saprophyticus, Streptococcus agalactiae, Streptococcus mutans Streptococcus pneumonia, Streptococcus pyogenes, Treponema pallidum, Vibrio cholera, Vibrio harveyi and Yersinia pestis.

Optionally, in the fibre filter 10, the disinfecting agent is arranged to inhibit fungi, wherein the fungi include at least one of: Absidia corymbifera, Ajellomyces capsulatus, Ajellomyces dermatitidis, Arthroderma benhamiae, Arthroderma fulvum, Arthroderma gypseum, Arthroderma incurvatum, Arthroderma otae, Arthroderma vanbreuseghemii, Aspergillus flavus, Aspergillus fumigates, Aspergillus niger, Blastomyces dermatitidis, Candida albicans, Candida albicans var. stellatoidea, Candida dublinensis, Candida glabrata, Candida guilliermondii, Candida krusei, Candida parapsilosis, Candida pelliculosa, Candida tropicalis, Cladophialophora carrionii, Coccidioides immitis, Cryptococcus neoformans, Cunninghamella sp., Epidermophyton floccosum, Exophiala dermatitidis, Eilobasidiella neoformans, Eonsecaea pedrosoi, Geotrichum candidum, Histoplasma capsulatum, Hortaea wemeckii, Issatschenkia orientalis, Madurella grisae, Malassezia furfur, Malassezia furfur complex, Malassezia globosa, Malassezia obtuse, Malassezia pachydermatis, Malassezia restricta, Malassezia slooffiae, Malassezia sympodialis, Microsporum canis, Microsporum fulvum, Microsporum gypseum, Microsporum gypseum complex, Microsporum gypseum, Mucor circinelloides, Nectria haematococca, Paecilomyces variotii, Paracoccidioides brasiliensis, Penicilliurn marneffei, Phialophora verrucosa, Pichia anomala, Pichia guilliermondii, Pneumocystis jirovecii, Pseudallescheria boydii, Rhizopus oryzae, Rodotorula rubra, Saccharomyces cerevisiae, Scedosporium apiospermum, Schizophyllum commune, Sporothrix schenckii, Stachybotrys chartarum. Trichophyton mentagrophytes. Trichophyton mentagrophytes complex, Trichophyton mentagrophytes. Trichophyton mentagrophytes. Trichophyton rubrum, Trichophyton tonsurans.

The fibre filter 10 is susceptible to being used in many situations having industrial applicability, for example in filters of air-conditioning equipment, in emergency breathing apparatus, in face masks to protect against pathogenic microbes (for example Covid-19 and related SARS-type viruses), in aircraft air filters, in automotive cabin air filters and so forth. A major advantage of the fibre filter 10 is that the aforesaid disinfecting agent is devoid of Silver therein. Moreover, the aforesaid disinfecting agent is capable of providing the fibre filter 10 with a longer effective lifetime than feasible for Silver-based filters. Yet additionally, the fibre filter 10 is susceptible to being washed and then reused, and yet maintaining its antimicrobial activity after washing on account of the use of the aforesaid disinfecting agent; such effectiveness is especially well maintained after washing if washing causes the disinfecting agent present within the at least one fibre 20 to migrate or diffuse from an interior region of the at least one fibre 20 to a surface region of the at least one fibre 20.

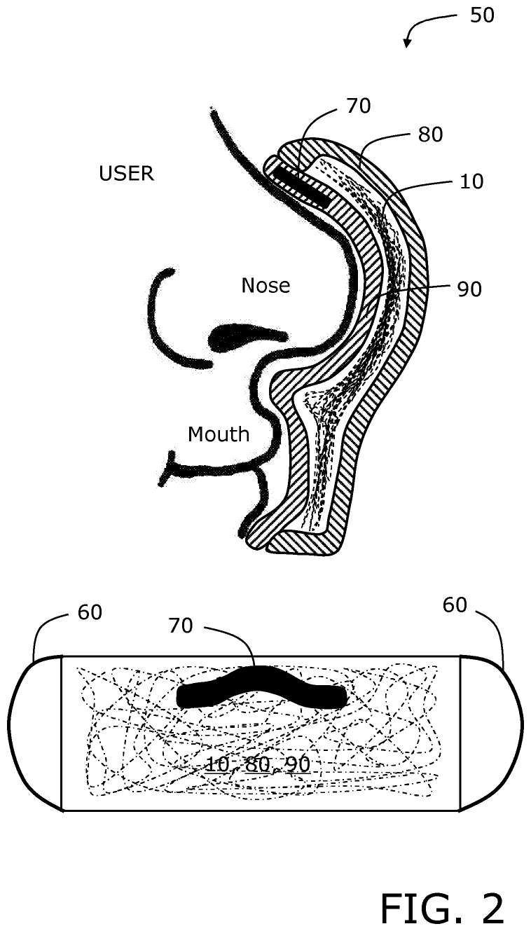

Referring next to FIG. 2, there is shown a face mask 50 that includes the fibre filter 10 of FIG. 1. The face mask 50 is configured to cover a nose region and a mouth region of a user, wherein the face mask 50 includes two elastic loops 60 that are configured to engage around a rear region of the user's ear pinnas, and a stiffening element 70 (for example, fabricated from a plastics material such as polyethylene or polypropylene) that is contoured to fit the face mask 50 comfortably around the noise region of the user. The face mask 50 includes an outer layer 80 that faces away from a user when the face mask 50 is being worn by the user, and an inner layer 90 that faces towards the user when the face mask 50 is being worn by the user. The fibre filter 10 is included between the outer layer and the inner layer 90 and is used to filter an air flow being breathed in and out of the user, to inhibit (for example to kill) any microbes present in the air flow.

The face mask 50 is washable and re-usable, while maintaining its antimicrobial performance. The foresaid disinfecting agent enables the face mask 50 to be effective over a relatively long period of use, for example for weeks or even months of use by the user.

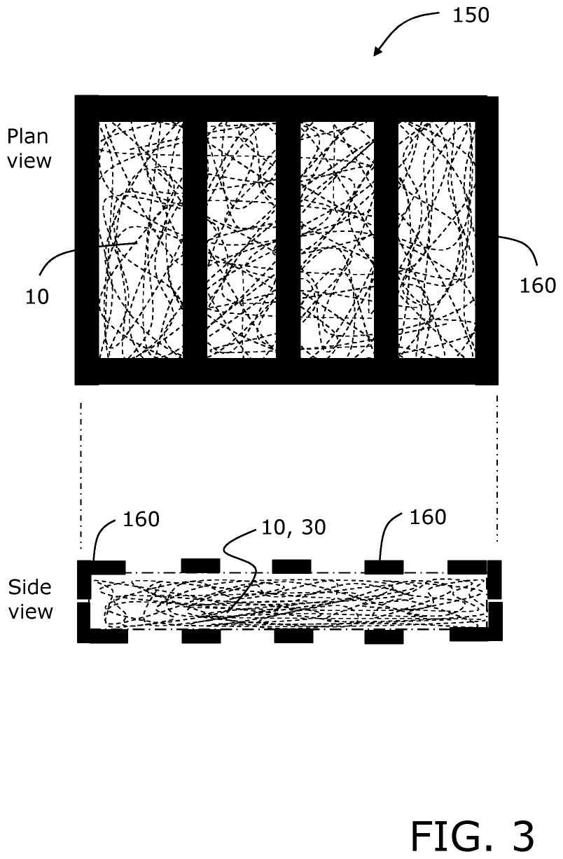

Referring next to FIG. 3, there is shown an illustration of an air filter for an air-conditioning unit, wherein the air filter is indicated generally by 150. The air filter 150 includes the fibre filter 10 disposed within a frame 160 that slots, clips or slides into the conventional air-conditioning unit (namely, a heat pump unit). The frame 160 is beneficially fabricated from a plastics material. Optionally, the frame 160 includes a plurality of parts that are coupled together (for example by clip engagement, thermal welding, adhesive or fasteners, or any combination thereof) to retain the fibre filter 10 within the air filter 150. The air filter 150 is used to inhibit (for example, kill) microbes that are carried in an air flow that enters into the air conditioning unit or an air flow that is ejected from the air conditioning unit. In a similar manner to the aforesaid face mask 50, the air filter 150 can be re-used by washing and yet will maintain its antimicrobial performance, in a same manner as the face mask 50 can be washed and reused.

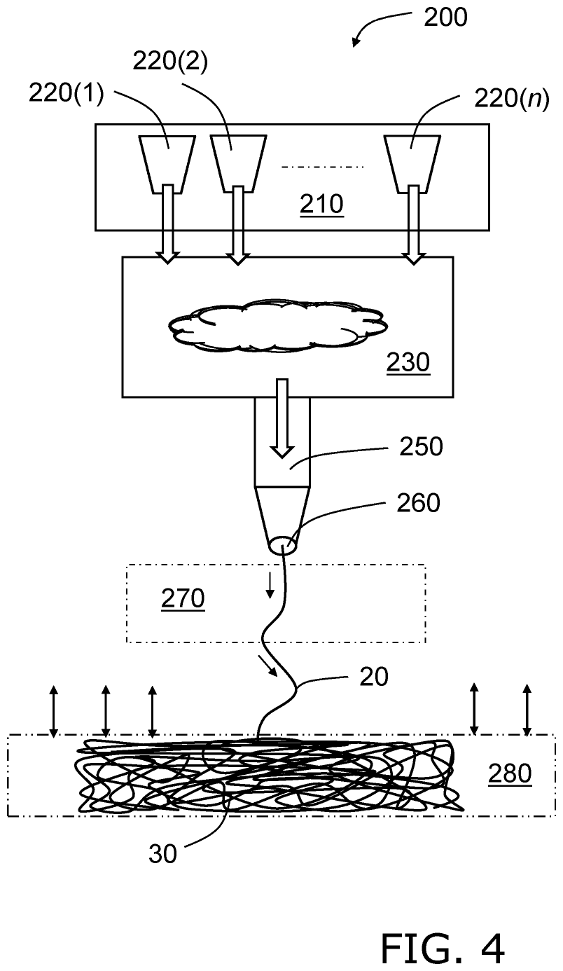

Referring next to FIG. 4, there is shown an apparatus for manufacturing the at least one fibre 20, for example for use in the fibre filter 10; the apparatus is indicated generally by 200. The apparatus 200 includes a feed hopper arrangement 210 including a plurality of reservoirs 220(1) to 220(n), wherein n is an integer. Beneficially, the integer n has a value of at least 2, wherein the first reservoir 220(1) is configured to include a plastics material powder or pellets, for example as aforementioned, for producing the at least one fibre 20, and a second reservoir 220(2) includes the aforesaid disinfecting agent. The aforesaid disinfecting agent is of benefit in that it can withstand a melting temperature of the plastics material in the first reservoir 220(1) without becoming denatured. Optionally, other of the reservoirs include other types of additive, for example porosity enhancing agents and diffusing agents to assist the disinfecting agent to migrate within the at least one fibre 20. The plurality of reservoirs 220(1) to 220(n) can also beneficially optionally including colouring agents.

The reservoirs of the hopper arrangement 210 are coupled to a mixing arrangement 230 that, when in operation, is heated above a melting temperature of the aforesaid plastics material. At a lower region of the mixing arrangement 230 is included a nozzle 250 including an aperture 260 from which a strand forming the at least one fibre 20 can be pulled from a melt provided from in the mixing arrangement 230, wherein the melt includes a liquid mixture of materials provided from the reservoirs 220(1) to 220(n). Near the aperture 260 is included a cooling arrangement 270, for example a cold air blower, for cooling the at least one fibre 20 as it is pulled from the aperture 260.

The at least one fibre 20, when pulled from the apparatus 200, can be wound onto a reel for subsequent use, or alternatively fed into a matting arrangement 280 in which the at least one fibre 20 is folded back onto itself and teased so as to form a dense felt mass that is then compressed to interlock folds of the at least one fibre 20 together to form the fibre filter 10. Optionally, heat energy is applied the fibre filter 10, below a melting point of the at least one fibre 20, to assist such interlocking when manufacturing the fibre filter 10.

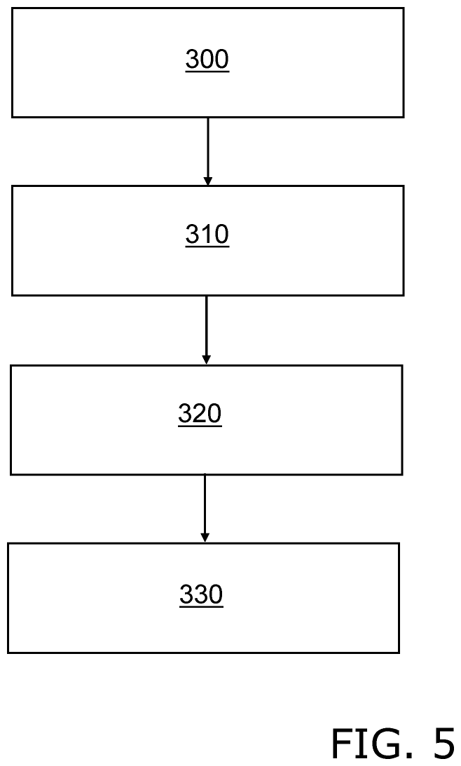

Referring to FIG. 5, there is shown a flow chart of steps of a method for (namely, a method of) manufacturing the aforesaid fibre filter 10. In a first step 300 of the method, the aforesaid plastics material is heated to a melted state to form a melt, and then the aforesaid disinfecting agent is added to the melt. In a second step 310, the melt is pulled through an aperture to form a fibre that is then pulled through a cooling zone. In a third step 320, the cooled fibre is collected together and teased to form a compact felt mass that is then compressed, and optionally heated at below a temperature required melting of the aforesaid melt, to interlock fibres of the compact mesh mesh. In a fourth step 330, the compact felt mass is then trimmed to size, for example using a guillotine or laser beam cutter, to form the fibre filter 10 to a specific size, for example to a size suitable for manufacturing the face mark 50 or the air filter 150.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

### Appendix

### From WO/TR2018/050314—Disinfectant Material

Teachings of the published PCT patent application WO/TR2018/050314 are herewith incorporated by reference. Disinfecting materials that can be used in embodiments of the present disclosure (for example, the face mask 50 and the air-flow filter 150), are, for example, defined by one or more following statements disclosed in the published PCT patent application WO/TR2018/050314:

Statement 1: The published PCT patent application discloses a use of a polymeric guanidine derivative based on a diamine containing oxyalkylene chains between two amino groups, with combination polymeric guanidine derivative based on a diamine containing oxyalkylene chains between two amino groups, with the guanidine derivative representing a product of polycondensation between a guanidine acid addition salt and a diamine containing polyoxyalkylene chains between two amino groups, Hexamethylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent., poly(hexamethylendiamine guanidinium chloride), Polietheramine derivatives (JEFF AMINE EDR-148), Polietheramine (Triethyleneglycol diamine (TEGDA) enzymes, PGPR, amino acids, antioxidants like humic acids and some natural products like phytotherapeutic plant extracts are also beneficially used.

Statement 2: The use disclosed in statement 1 can be further characterized in that, in the examples of the family of polyoxyalkylene guanidine salts, there are used triethylene glycol diamine (relative molecular mass: 148), polyoxypropylene diamine (relative molecular mass: 230) as well as polyoxyethylene diamine (relative molecular mass: 600).

Statement 3: The use disclosed in statement 1 or 2 can be further characterized in that the poly-[2-(2-_ethoxyethoxyethyl)_guanidinium hydrochloride] has at least 3 guanidinium groups.

Statement 4: The use in statement 3 can be further characterized in that the average molecular mass of the polymeric guanidine derivative ranges from 500 to 3000.

Statement 5: The use according to any one of statements 1 to 4 can be further characterized in that the polymeric guanidine derivative is designed as a drug composition for veterinary use.

Statement 6: The use according to statement 1 can be further characterized in that there is used the combination guanidinium derivatives, particularly pertaining to a combination polymeric guanidine derivative based on a diamine containing oxyalkylene chains between two amino groups, with the guanidine derivative representing a product of polycondensation between a guanidine acid addition salt and a diamine containing polyoxyalkylene chains between two amino groups, Hexamethylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent., poly(hexamethylendiamine guanidinium chloride), Polietheramine derivatives (JEFF AMINE EDR-148), Polietheramine (Triethyleneglycol diamine (TEGDA) enzymes, PGPR, amino acids, antioxidants like humic acids and some natural products like phytotherapeutic plant extracts can apply at least 3000 mg/l, preferably at least 2000 mg/l, more preferably at least 2000 mg/l to protecting agent from pathogens organism at surface, air, textile, paint, plastic, silicone and wood, polyethylene and derivatives

Statement 7: The polymeric guanidine derivative composition relating to the use in statement 1 can be arranged such that the guanidinium compound is oligo(2-(2-ethoxy)ethoxy ethyl guanidinium chloride).

Statement 8: The polymeric guanidine derivative relating to the use in statement 1 can be further characterized in that the guanidinium compound is poly(hexamethylendiamine guanidiniumchloride), and pH of synthesis of product which combination polymeric guanidine derivative based on a diamine containing oxyalkylene chains between two amino groups, with the guanidine derivative representing a product of polycondensation between a guanidine acid addition salt and a diamine containing polyoxyalkylene chains between two amino groups, Hexamethylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent., poly(hexamethylendiamine guanidinium chloride), Poliethera mine derivatives (3EFFAMINE EDR-148), Polietheramine (Triethyleneglycol diamine (TEGDA) enzymes, PGPR, amino acids, antioxidants like humic acids and some natural products like phytotherapeutic plant extracts protecting composition according to claim 1 characterised in that it has a from 5.5 to 7.5.

Statement 9: The use according to statement 1 can be further characterized in that there is used a synthesis product based on a diamine containing oxyalkylene chains between two amino groups, with the guanidine derivative representing a product of polycondensation between a guanidine acid addition salt and a diamine containing polyoxyalkylene chains between two amino groups, Hexamethylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent., poly(hexamethylendiamine guanidinium chloride), Polietheramine derivatives (JEFFAMINE EDR-148), Polietheramine (Triethyleneglycol diamine (TEGDA) enzymes, PGPR, amino acids, antioxidants like humic acids and some natural products like phytotherapeutic plant extracts protect surface, air, textile, paint, plastic, silicone and wood, polyethylene and derivatives which apllied the general structure of textile, paint, plastic, silicone and wood, polyethylene materials.

Statement 10: The use of statement 1 can be further characterized in that the herbal plants include at least one of: Aniseed (Anisi fructus), Barbados Aloes (Aloe barbadensis), Bearberry leaf (Uvae ursi folium), Bilberry Fruit (Myrtilli fructus), Birch Leaf (Betulae folium), Black Cohosh (Cimicifugae rhizoma), Black Currant Leaf (Ribis nigri folium), Black Horehound (Ballotae nigrae herba), Bogbean leaf (Menyanthidis trifoliatae folium), Burdock Root (Arctii radix), Butcher's Broom (Rusci rhizome), Cape Aloes (Aloe capensis), Cascara (Rhamni purshianae cortex), Centaury(Centaurii herba), Clove oil (Caryophylli aetheroleum), Cola (Colae semen), Comfrey root (Symphyti radix), Couch Grass Rhizome (Graminis rhizoma), Elder flower (Sambuci flos), Feverfew (Tanaceti parthenii herba), Frangula Bark (Frangulae cortex), Gentian Root (Gentianae radix), Grindelia (Grindeliae herba), Hamamelis bark (Hamamelidis cortex), Hamamelis leaf (Hamamelidis folium), Hamamelis water (Hamamelidis aqua), Hydrastis rhizoma (Goldenseal rhizome), Ispaghula Husk (Plantaginis ovatae testa), Java Tea (Orthosiphonis folium), Lady's Mantle (Alchemillae herba), Linseed (Lini semen), Mallow Flower (Malvae flos), Meadowsweet (Filipendulae ulmariae herba), Melissa leaf (Melissae folium), Myrrh (Myrrha), Mullein flower (Verbasci flos), Nettle Root (Urticae radix), Pelargonium Root (Pelargonii radix), Psyllium Seed (Psylli semen), Restharrow Root (Ononidis radix), Rhatany Root (Ratanhiae radix), Ribwort Plantain leaf/herb (Plantaginis lanceolatae folium/herba), Sage Leaf, Trilobed (Salviae trilobae folium), Tormentil (Tormentillae rhizoma), White Horehound (Marrubii herbal), Wild Pansy (Violae herba cum flore), Wild Thyme (Serpylli herba), Willow Bark (Salicis cortex).

Statement 11: The use according to statement 1 can be further characterized in that the use is beneficial to inhibit organisms associated with diseases caused by Fusarium spp., e.g. Fusarium semitectum, Fusarium moniliforme, Fusarium solani, Fusarium oxysporum; Verticillium spp., e.g. Verticillium theobromae; Nigrospora spp.; Botrytis spp., e.g. Botrytis cinerea; Geotrichum spp., e.g. Geotrichum candidum; Phomopsis spp., Phomopsis natalensis; Diplodia spp., e.g. Diplodia citri; Alternaria spp., e.g. Alternaria citri, Alternaria altemata; Phytophthora spp., e.g. Phytophthora citrophthora, Phytophthora fragariae, Phytophthora cactorum, Phytophthora parasitica; Septoria spp., e.g. Septoria depressa; Mucor spp., e.g. Mucor piriformis; Monilinia spp., e.g. Monilinia fructigena, Monilinia laxa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Penicillium spp., e.g. Penicillium funiculosum, Penicillium expansum, Penicillium digitatum, Penicillium italicum; Gloeosporium spp., e.g. Gloeosporium album, Gloeosporium perennans, Gloeosporium fructi genum, Gloeosporium singulata; Phlyctaena spp., e.g. Phlyctaena vagabunda; Cylindrocarpon spp., e.g. Cylindrocarpon mali; Stemphyllium spp., e.g. Stemphyllium vesicarium; Phacydiopycnis spp., e.g. Phacydiopycnis malirum; Thielaviopsis spp., e.g. Thielaviopsis paradoxy; Aspergillus spp., e.g. Aspergillus niger, Aspergillus carbonarius; Nectria spp., e.g. Nectria galligena; Pezicula spp., Escherichia Coli, Enterobacter sakazakii, Salmonella, pseudomonas, escheria coli, entereobacter aerogenes, coliform, legionalla, Salmonella spp., Campylobacter spp., Staphylococcus aureus, Listeria monocytogenes, Bacillus cereus, Clostridium spp., Escherichia coli O157:H7, Shigella spp., Yersinia enterocolitica, Vibrio spp., Brucella spp. ve Aeromonas spp. and Campylobacter.

This microbes are susceptible to being destroyed using the aforesaid a polymeric guanidine derivative product which contains oxyalkylene chains between two amino groups, with the guanidine derivative representing a product of polycondensation between a guanidine acid addition salt and a diamine containing polyoxyalkylene chains between two amino groups, Hexamethylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent., poly(hexamethylendiamine guanidinium chloride), Polietherannine derivatives (JEFFAMINE EDR-148), Polietherannine(Triethyleneglycol diamine (TEGDA) enzymes, PGPR, amino acids, antioxidants like humic acids and some natural products like phytotherapeutic plant extracts.

Statement 12: The ionene polymers and compositions disclosed in the published PCT application are also particularly useful for inhibiting the growth and dissemination, of microorganisms, particularly on surfaces where such growth is undesirable. The term “inhibiting the growth of microorganisms” means that the growth, dissemination, accumulation, and/or the attachment, for example to a susceptible surface, of one or more microorganisms is impaired, retarded, eliminated or prevented. Beneficially, the antimicrobial compositions are used in methods for inhibiting the growth of an organism on susceptible surfaces in health-related environments. The term “health-related environment” as used herein includes all those environments where activities are carried out directly or indirectly, that are implicated in the restoration or maintenance of human health. A health-related environment can be a medical environment, where activities are carried out to restore human health. An operating room, a doctor's office, a hospital room, and a factory making medical equipment are all examples of health-related environments. Other health-related environments can include industrial or residential sites where activities pertaining to human health are carried out such as activities including food processing, water purification, recreational water maintenance, and sanitation.

The term “susceptible surface” as used herein refers to any surface whether in an industrial or medical setting, that provides an interface between an object and the fluid. A surface, as understood herein further provides a plane whose mechanical structure, without further treatment, is compatible with the adherence of microorganisms. Microbial growth and/or biofilm formation with health implications can involve those surfaces in all health-related environments. Such surfaces include, but are not limited to, scalpels, needles, scissors and other devices used in invasive surgical, therapeutic or diagnostic procedures; implantable medical devices, including artificial blood vessels, catheters and other devices for the removal or delivery of fluids to patients, artificial hearts, artificial kidneys, orthopaedic pins, plates and implants; catheters and other tubes (including urological and biliary tubes, endotracheal tubes, peripherally insertable central venous catheters, dialysis catheters, long term tunneled central venous catheters, peripheral venous catheters, pulmonary catheters, Swan-Ganz catheters, urinary catheters, peritoneal catheters), urinary devices (including long term urinary devices, tissue bonding urinary devices, artificial urinary sphincters, urinary dilators), shunts (including ventricular or arterio-venous shunts); prostheses, (including breast implants, penile prostheses, vascular grafting prostheses, heart valves, artificial joints, artificial larynxes, otological implants), vascular catheter ports, wound drain tubes, hydrocephalus shunts, pacemakers and implantable defibrillators, and the like.

Other surfaces include the inner and outer surfaces of pieces of medical equipment, medical gear worn or carried by personnel in the health care settings and protective clothing for biohazard or biological warfare applications. Such surfaces can include counter tops and fixtures in areas used for medical procedures or for preparing medical apparatus, tubes and canisters used in respiratory treatments, including the administration of oxygen, solubilized drugs in nebulizers, and anaesthetic agents. Additional surfaces include those surfaces intended as biological barriers to infectious organisms such as gloves, aprons and face-shields.

Surfaces in contact with liquids are particularly prone to microbial growth and/or biofilm formation. As an example, those reservoirs and tubes used for delivering humidified oxygen to patients can bear biofilms inhabited by infectious agents. Dental unit waterlines similarly can bear biofilms on their surfaces, providing a reservoir for continuing contamination of the system of flowing and aerosolized water used in dentistry.

Other surfaces related to health include the inner and outer surfaces of equipment used in water purification, water storage and water delivery, and those articles involved in food processing equipment for home use, materials for infant care and toilet bowls.

Statement 13: Other means for contacting include a sustained or controlled release system that provides constant or prolonged release of an agent of the invention from a susceptible surface. This can be accomplished through the use of diffusional systems, including reservoir devices in which a core of an agent of the invention is surrounded by a porous membrane or layer, and also matrix devices in which the compound is distributed throughout an inert matrix. Materials which may be used to form reservoirs or matrices include silicones, acrylates, methacrylates, vinyl compounds such as polyvinyl chloride, olefins such as polyethylene or polypropylene, fluoropolymers such as polytetrafluorethylene or polypropylene, fluoropolymers such as polytetrafluorethylene, and polyesters such as terephthalates. Alternatively, the compositions of the invention may be mixed with a resin, for example polyvinyl chloride, and then moulded into a formed article, which integrally incorporates the compound to form a structure having a porous matrix which allows diffusion of the compound or a functional portion thereof into the surrounding environment. Microencapsulation techniques can also be used to maintain a sustained focal release of a compound of the disclosure.

Statement 14: For the use of statement 1, an article is provided comprising a polymer of the polymeric guanidine derivative in an amount sufficient to prevent, inhibit or eliminate the growth or dissemination of a microorganism or the formation of a biofilm, namely an “effective amount.” The polymer can be in the article or on the surface of the article. Beneficially, the article is coated with a composition comprising an effective amount of a polymer of the present invention. Articles that are advantageously coated with aforesaid polymer are those in which inhibition of the growth of microorganisms and/or biofilrns is desirable, for example medical devices, medical furniture and devices exposed to aqueous environments.

Statement 15: In accordance with these and other aspects, the present invention provides novel ionene polymers having antimicrobial activity, based on a combination polymeric guanidine derivative based on a diamine containing oxyalkylene chains between two amino groups, with the guanidine derivative representing a product of polycondensation between a guanidine acid addition salt and a diamine containing polyoxyalkylene chains between two amino groups, Hexamethylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent, poly(hexamethylendiamine guanidinium chloride), Polietheramine derivatives (JEFFAMINE EDR-148), Polietheramine (Triethyleneglycol diamine (TEGDA) enzymes, PGPR, amino acids, antioxidants like humic adds and some natural products like phytotherapeutic plant extracts” or “synthesis product,” as used, are cationic polymers or copolymers with amine groups in the main polymeric chain or backbone of the polymer, providing a positive charge. The ioene polymers has been found to be non-irritating and low in toxicity to warm-blooded animals. The PCT publication further provides antimicrobial compositions comprising at least one synthesis and methods for preventing, inhibiting or eliminating the growth, dissemination, and/or the accumulation of microorganisms on a susceptible surface such as surface, air, textile, paint, plastic, silicone and wood, polyethylene and derivatives.

Statement 16: In statement 1, the use includes using ionene polymers having antimicrobial activity by using a combination polymeric guanidine derivative; the guanidine derivative is, for example, based on a diamine containing oxyalkylene chains between two amino groups, with the guanidine derivative representing a product of polycondensation between a guanidine acid addition salt and a diamine containing polyoxyalkylene chains between two amino groups, Hexamethylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent., poly(hexamethylendiamine guanidinium chloride), Polietheramine derivatives (3EFFAMINE EDR-148), Polietheramine (Triethyleneglycol diamine (TEGDA) enzymes, PGPR, amino acids, antioxidants like humic acids and some natural products like phytotherapeutic plant extracts or “synthesis product”, are cationic polymers or copolymers with amine groups in the main polymeric chain or backbone of the polymer, providing a positive charge. Such synthesis has been found to be non-irritating and low in toxicity to warm-blooded animals. There are from aforesaid disclosure provided antimicrobial compositions comprising at least one synthesis and methods for preventing, inhibiting or eliminating the growth, dissemination, and/or the accumulation of microorganisms on a susceptible surface such as surface, aft, textile, paint, plastic, silicone and wood, polyethylene and derivatives.

Statement 17: The aforesaid use is especially relevant when inhibiting certain types of microbes, for example for inhibiting gram-negative bacterial pathogens, for example against bacteria and bacteria from the genus Fusarium spp., e.g. Fusarium semitectum, Fusarium moniliforme, Fusarium solani, Fusarium oxysporum; Verticillium spp., e.g. Verticillium theobromae; Nigrospora spp.; Botrytis spp., e.g. Botrytis cinerea; Geotrichum spp., e.g. Geotrichum candidum; Phomopsis spp., Phomopsis natalensis; Diplodia spp., e.g. Diplodia citri; Alternaria spp., e.g. Alternaria citri, Alternaria alternata; Phytophthora spp., e.g. Phytophthora citrophthora, Phytophthora fragariae, Phytophthora cactorum, Phytophthora parasitica; Septoria spp., e.g. Septoria depressa; Mucor spp., e.g. Mucor piriformis; Monilinia spp., e.g. Monilinia fructigena, Monilinia laxa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Penicillium spp., e.g. Penicillium funiculosum, Penicillium expansum, Penicillium digitatum, Penicillium italicum; Gloeosporiunn spp., e.g. Gloeosporiunn album, Gloeosporium perennans, Gloeosporium fructi genum, Gloeosporium singulata; Phlyctaena spp., e.g. Phlyctaena vagabunda; Cylindrocarpon spp., e.g. Cylin drocarpon mali; Stemphyllium spp., e.g. Stemphyllium vesicarium; Phacydiopycnis spp., e.g. Phacydiopycnis malirum; Thielaviopsis spp., e.g. Thielaviopsis paradoxy; Aspergillus spp., Aspergillus niger, Aspergillus carbonarius; Nectria spp., e.g. Nectria galligena; Pezicula spp., Escherichia Coli, Enterobacter sakazakii, Salmonella, pseudomonas, escheria coli, entereobacter aerogenes, coliform, legionalla, Salmomella spp., Campylobacter spp., Staphylococcus aureus, Listeria monocytogenes, Bacillus cereus, Clostridium spp., Escherichia coli O157:H7, Shigella spp., Yersinia enterocolitica, Vibrio spp., Brucella spp. ye Aeromonas spp. and Campylobacter.

Moreover, the use of statement 1 includes inhibiting gram-negative bacterial pathogens and some fungie such as Fusarium spp., e.g. Fusarium semitectum, Fusarium moniliforme, Fusarium solani, Fusarium oxysporum; Verticillium spp., e.g. Verticillium theobromae; Nigrospora spp.; Botrytis spp., e.g. Botrytis cinerea; Geotrichum spp., e.g. Geotrichum candidum; Phomopsis spp., Phomopsis natalensis; Diplodia spp., e.g. Diplodia citri; Altemaria spp., e.g. Alternaria citri, Alternaria alternata; Phytophthora spp., e.g. Phytophthora citrophthora, Phytophthora fragariae, Phytophthora cactorum, Phytophthora parasitica; Septoria spp., e.g. Septoria depressa; Mucor spp., e.g. Mucor piriformis; Monilinia spp., e.g. Monilinia fructigena, Monilinia laxa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Penicillium spp., e.g. Penicillium funiculosum, Penicillium expansum, Penicillium digitatum, Penicillium italicum; Gloeosporium spp., e.g. Gloeosporium album, Gloeosporium perennans, Gloeosporium fructi genum, Gloeosporium singulata; Phlyctaena spp., e.g. Phlyctaena vagabunda; Cylindrocarpon spp., e.g. Cylin drocarpon mali; Stemphyllium spp., e.g. Stemphyllium vesicarium; Phacydiopycnis spp., e.g. Phacydiopycnis malirum; Thielaviopsis spp., e.g. Thielaviopsis paradoxy; Aspergillus spp., e.g. Aspergillus niger, Aspergillus carbonarius; Nectria spp., e.g. Nectria galligena; Pezicula spp., Escherichia Coli, Enterobacter sakazakii, Salmonella, pseudomonas, escheria coli, entereobacter aerogenes, coliform, legionalla, Salmomella spp., Campylobacter spp., Staphylococcus aureus, Listeria monocytogenes, Bacillus cereus, Clostridium spp., Escherichia coli O157:H7, Shigella spp., Yersinia enterocolitica, Vibrio spp., Brucella spp. ve Aeromonas spp. and Campylobacter.

Statement 18: The use of statement 1 includes inhibiting gram-negative bacterial pathogens and fungie such as Fusarium spp., e.g. Fusarium semitectum, Fusarium moniliforme, Fusarium solani, Fusarium oxysporum; Verticillium spp., e.g. Verticillium theobromae; Nigrospora spp.; Botrytis spp., e.g. Botrytis cinerea; Geotrichum spp., e.g. Geotrichum candidum; Phomopsis spp., Phomopsis natalensis; Diplodia spp., e.g. Diplodia citri; Alternaria spp., e.g. Altemaria citri, Alternaria alternata; Phytophthora spp., e.g. Phytophthora citrophthora, Phytophthora fragariae, Phytophthora cactorum, Phytophthora parasitica; Septoria spp., e.g. Septoria depressa; Mucor spp., e.g. Mucor piriformis; Monilinia spp., e.g. Monilinia fructigena, Monilinia laxa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Penicillium spp., e.g. Penicillium funiculosum, Penicillium expansum, Penicillium digitatum, Penicillium italicum; Gloeosporium spp., e.g. Gloeosporium album, Gloeosporium perennans, Gloeosporium fructi genum, Gloeosporium singulata; Phlyctaena spp., e.g. Phlyctaena vagabunda; Cylindrocarpon spp., e.g. Cylin drocarpon mali; Stemphyllium spp., e.g. Stemphyllium vesicarium; Phacydiopycnis spp., e.g. Phacydiopycnis malirum; Thielaviopsis spp., e.g. Thielaviopsis paradoxy; Aspergillus spp., e.g. Aspergillus niger, Aspergillus carbonarius; Nectria spp., e.g. Nectria galligena; Pezicula spp., Escherichia Coli, Enterobacter sakazakii, Salmonella, pseudomonas, escheria coli, entereobacter aerogenes, coliform, legionalla, Salmomella spp., Campylobacter spp., Staphylococcus aureus, Listeria monocytogenes, Bacillus cereus, Clostridium spp., Escherichia coli O157:H7, Shigella spp., Yersinia enterocolitica, Vibrio spp., Brucella spp. ve Aeromonas spp. and Campylobacter said pathogens produce toxine and/or cause infections.

1.-20. (canceled)

21. A fibre filter for filtering a flow of gas therethrough, wherein the fibre filter includes a fibre felt including at least one fibre that is matted together, wherein the at least one fibre is manufactured from a plastics material that includes integrally therein a disinfecting agent that inhibits activity of microbes that are deposited on the at least one fibre when the flow of gas occurs through the fibre filter.

22. The fibre filter of claim 21, wherein the microbes include at least one of: bacteria, viruses, fungi.

23. The fibre filter of claim 21, wherein the plastics material includes at least one of:
polyester, polyethylene, polypropylene, polyethylene terephthalate, polyvinyl chloride, polystyrene, polylactic acid, polycarbonate, polymethyl methacrylate, polyoxymethylene, aliphatic polyamide (nylon), semi-aromatic polyamide (nylon), acrylonitrile butadiene styrene, acrylic plastics material.

24. The fibre filter of claim 21, wherein the at least one fibre is porous to allow the microbes to migrate into the at least one fibre to contact the disinfecting agent therein.

25. The fibre filter of claim 21, wherein the at least one fibre is porous and includes a diffusing agent that is arranged to transport the disinfecting agent from within the at least one fibre to an outer surface of the at least one fibre to replenish its anti-microbial characteristics as a function of an age of the fibre filter.

26. The fibre filter of claim 21, wherein the disinfecting agent includes a polymeric guanidine derivative.

27. The fibre filter of claim 26, wherein the polymeric guanidine derivative is based on a diamine containing oxyalkylene chains between two amino groups, with a combination polymeric guanidine derivative based on a diamine containing oxyalkylene chains between two amino groups, with the guanidine derivative representing a product of polycondensation between a guanidine acid addition salt and a diamine containing polyoxyalkylene chains between two amino groups.

28. The fibre filter of claim 27, wherein the disinfecting agent further includes at least one of: hexamethylenediamine (1,6-hexanediamine) guanidinium derivatives, particularly to combinations of oligo(2-(2-ethoxy)ethoxy ethyl guanidinium chloride), modified polyhexamethylene guanidine (PHMG) as an antimicrobial agent, poly(hexamethylendiamine guanidinium chloride), Polietheramine derivatives (JEFF AMINE EDR-148), Polietheramine (Triethyleneglycol diamine (TEGDA)) enzymes, PGPR, amino acids, antioxidants including humic acids, and phytotherapeutic plant extracts.

29. The fibre filter of claim 27, wherein the disinfecting agent has an average molecular mass in a range of 500 to 3000.

30. The fibre filter of claim 27, wherein the guanidinium derivative includes oligo(2-(2-ethoxy)ethoxy ethyl guanidinium chloride).

31. The fibre filter of claim 27, wherein the at least one fibre has a diameter in a range of 50 mm to 1 mm.

32. The fibre filter of claim 31, wherein the fibre felt has a thickness in a range of 0.5 mm to 5.0 mm.

33. The fibre filter of claim 32, wherein the fibre felt has a thickness in a range of 1 mm to 3 mm.

34. The fibre filter of claim 21, wherein a ratio of volume of the at least one fibre within the fibre felt relative to a volume of voids present in the fibre felt is in a range of 50:50 to 5000:50.

35. The fibre filter of claim 21, wherein the disinfecting agent is arranged to inhibit bacteria, wherein the bacteria include at least one of: Bordetella pertussis, Borrelia burgdorferi, Brucella abortus, Brucella canis, Brucella melitensis, Brucella suis, Campylobacter jejuni, Chlamydia pneumonia, Chlamydia psittaci, Chlamydia trachomatis, Clostridium botulinum Clostridium Clostridium perfringens, Clostridium tetani, Corynebacterium diphtheria, Enterococcus faecalis, Enterococcus faecium, Escherichia coil (E. coli), Enterotoxigenic Escherichia coli (ETEC), Enteropathogenic E. coli, Erancisella tularensis, Haemophilus influenza, Helicobacter Legionella pneumophila, Leptospira interrogans, Listeria monocytogenes, Mycobacterium leprae, Mycobacterium tuberculosis, Mycoplasma pneumonia, Neisseria gonorrhoeae, Neisseria meningitidis, Pseudomonas aeruginosa, Rickettsia rickettsia, Salmonella typhi, Salmonella typhimurium, Shigella sonnei, Staphylococcus epidermidis, Staphylococcus saprophyticus, Streptococcus agalactiae, Streptococcus mutans Streptococcus pneumonia, Streptococcus pyogenes, Treponema pallidum, Vibrio cholera, Vibrio harveyi and Yersinia pestis.

36. A face mask for protecting a user thereof from inhaling microbes, wherein the face mask includes an outwards-facing fabric layer when the face mask is worn by the user, an inwards-facing fabric layer that faces towards a mouth and nose of the user when the face mask is worn by the user, and a fibre filter of any one of the preceding claims included between the outwards-facing fabric layer and the inwards-facing fabric layer, wherein the fibre filter is configured to collect microbes from an air flow occurring through the face mask when in use, and to inhibit microbial activity of the microbes.

37. The face mask of claim 16, wherein the face mask includes a rigidity-enhancing element included in the face mask in a region thereof that abuts onto the nose of the user when the face mask is worn by the user.

38. The face mask of claim 17, wherein the face mask includes a strap arrangement that is secured around at least parts of ears of the user when the face mask is being worn by the user, wherein the strap arrangement is configured to hold the face mask against the mouth and nose of the user.

39. The face mask of claim 18, wherein the strap arrangement is implemented as elastic loop straps.

40. An air-filter for a heat pump unit, wherein the air-filter includes a fibre filter, wherein the fibre filter includes a fibre felt including at least one fibre that is matted together, wherein the at least one fibre is manufactured from a plastics material that includes integrally therein a disinfecting agent that inhibits activity of microbes that are deposited on the at least one fibre when the flow of gas occurs through the fibre filter, and wherein the fibre filter is supported by a frame that is configured to be fitted into the heat pump unit to intercept a flow of heated or cooled air between the heat pump unit and a spatial environment in which microbial activity is to be inhibited.
